(19) United States
(12) Patent Application Publication
(10) Pub. No.: US 2025/0234232 A1
(43) Pub. Date: Jul. 17, 2025

(54) METHODS AND APPARATUSES FOR COVERAGE DATA COLLECTION ENHANCEMENTS IN WIRELESS COMMUNICATIONS

(71) Applicant: InterDigital Patent Holdings, Inc., Wilmington, DE (US)

(72) Inventors: Filipe Conceicao, London (GB); Oumer Teyeb, Montreal (CA); James Miller, Northport, NY (US); Tezcan Cogalan, London (GB); Yugeswar Deenoo Narayanan Thangaraj, Chalfont, PA (US)

(73) Assignee: InterDigital Patent Holdings, Inc., Wilmington, DE (US)

(21) Appl. No.: 18/845,304

(22) PCT Filed: Mar. 23, 2023
(86) PCT No.: PCT/US2023/016020

§ 371 Date: Sep. 9, 2024

Related U.S. Application Data
(60) Provisional application No. 63/323,448, filed on Mar. 24, 2022.

(51) Int. Cl. H04W 24/10

(52) U.S. Cl. CPC H04W 24/10

(57) ABSTRACT

Methods, apparatuses, and procedures for enhancements of coverage data collection and measurement reporting in wireless communications are disclosed. For example, a method implemented by a wireless transmit/receive unit (WTRU) includes receiving configuration information for measurement reporting, the configuration information indicates one or more triggering conditions to start measurement and report measurement, one or more sets of parameters for measurement, and one or more measurement report configurations. The method also includes performing one or more measurements on at least one cell using the one or more sets of parameters and based on the one or more triggering conditions, and transmitting one or more measurement reports based on the one or more triggering conditions and the one or more measurement report configurations.

### CROSS-REFERENCE TO RELATED APPLICATIONS

This application claims priority to and the benefit of U.S. Provisional Application No. 63/323,448 filed in the U.S. Patent and Trademark Office on Mar. 24, 2022, the entire contents of which being incorporated herein by reference as if fully set forth below in its entirety and for all applicable purposes.

### BACKGROUND

In wireless communication networks, mobile devices (e.g., a wireless transmit/receive unit (WTRU)) may experience some radio interface inefficiencies, for example, coverage holes, and/or weak coverage spots. Current data collection mechanisms are insufficient, for example, for applications using artificial intelligence (AI) and/or machine learning (ML) techniques. In many instances, due to current measurement reporting specifications and implementations, sub-optimal coverage areas remain undetected. As such, new or enhanced methods, apparatuses, and procedures for coverage data collection in wireless communication networks (e.g., a 5G NR network) are desired.

### SUMMARY

Embodiments disclosed herein generally relate to communication networks, wireless and/or wired. One or more embodiments disclosed herein are related to methods, apparatuses, and procedures for enhancements of coverage data collection and measurement reporting in wireless communications (e.g., in a 5G New Radio (NR) system).

In one embodiment, a method implemented by a wireless transmit/receive unit (WTRU) includes receiving a first message including configuration information, wherein the configuration information includes an indication to the WTRU to perform measurement storage and/or measurement reporting, performing measurement storage based on the received indication and/or a determination that a first triggering condition is met, and sending one or more measurement reports based on the received indication and/or a determination that a second triggering condition is met.

In one embodiment, a method implemented by a WTRU includes receiving configuration information for measurement reporting, the configuration information indicates one or more triggering conditions to start measurement and report measurement, one or more sets of parameters for measurement, and one or more measurement report configurations. The method also includes performing one or more measurements on at least one cell using the one or more sets of parameters and based on the one or more triggering conditions, and transmitting one or more measurement reports based on the one or more triggering conditions and the one or more measurement report configurations.

In one embodiment, a method implemented by a WTRU includes receiving configuration information for measurement reporting, and the configuration information indicates: a first triggering condition to start measurement, a second triggering condition to report measurement, a first set of parameters and a second set of parameters for measurement, and/or a measurement report configuration. The method also includes performing, based on the first triggering condition being satisfied for at least one cell, a first measurement on the at least one cell using the first set of parameters and a second measurement on the at least one cell using the second set of parameters. The method further includes transmitting, based on the second triggering condition being satisfied and the measurement report configuration, a measurement report including at least the first measurement or the second measurement. In an example, the measurement report includes both the first measurement and the second measurement and is transmitted using the measurement report configuration.

In various embodiments, the first triggering condition comprises any of: information indicating a quality of service (QOS) degradation of the at least one cell, a measurement result for the at least one cell being equal to or less than a threshold, or an indication from a network. The second triggering condition may comprise any of: information indicating a QoS degradation of the at least one cell, a measurement result for the at least one cell being equal to or less than a threshold, an indication from a network, information indicating a measurement report size, or a radio link failure (RLF). In an example, the measurement report configuration comprises any of: a maximum payload size, a measurement report size, a pre-configured measurement reporting instance, or a pre-configured measurement reporting time. In an example, the measurement report is based on an RLF trigger and comprises snapshot information of measurement on the at least one cell. In some cases, the at least one cell comprises a cell associated with a configured radio access technology (RAT) (e.g., a configured 3GPP RAT), or a non-configured RAT (e.g., a non-configured 3GPP RAT), or a non-3GPP RAT.

In one embodiment, a WTRU comprising a processor, a receiver, a transmitter, and memory is configured to implement one or more methods disclosed herein. For example, the WTRU comprising circuitry, including a transmitter, a receiver, a processor, and memory, is configured to receive configuration information for measurement reporting, and the configuration information indicates a first triggering condition to start measurement, a second triggering condition to report measurement, a first set of parameters and a second set of parameters for measurement, and/or a measurement report configuration. The WTRU is further configured to perform, based on the first triggering condition being satisfied for at least one cell, a first measurement on the at least one cell using the first set of parameters and a second measurement on the at least one cell using the second set of parameters. The WTRU is further configured to transmit, based on the second triggering condition being satisfied and the measurement report configuration, a measurement report including at least the first measurement or the second measurement.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a diagram illustrating an example of a WTRU in mobility experiencing coverage holes and weak coverage spots;

FIG. 3 is a diagram illustrating an example timeline of measurement reporting by a WTRU, according to one or more embodiments;

FIG. 4 is a diagram illustrating an example timeline of measurement reporting and weak coverage detection at a WTRU, according to one or more embodiments;

FIG. 5 is a diagram illustrating an example timeline of configuring a WTRU with a time window corresponding to the time durations that the WTRU is expected to experience non-optimal coverage, according to one or more embodiments;

FIG. 6 is a flowchart illustrating an example procedure for semi-autonomous data collection and triggering of measurement collection and reporting, according to one or more embodiments;

FIG. 7 is a flowchart illustrating an example procedure for triggering of measurement collection and reporting, according to one or more embodiments;

FIG. 8 is a diagram illustrating an example timeline of measurement data collection and reporting by a WTRU, according to one or more embodiments; and

FIG. 9 is a flowchart illustrating an example procedure for measurement data collection and reporting by a WTRU, according to one or more embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System, Networks, and Devices

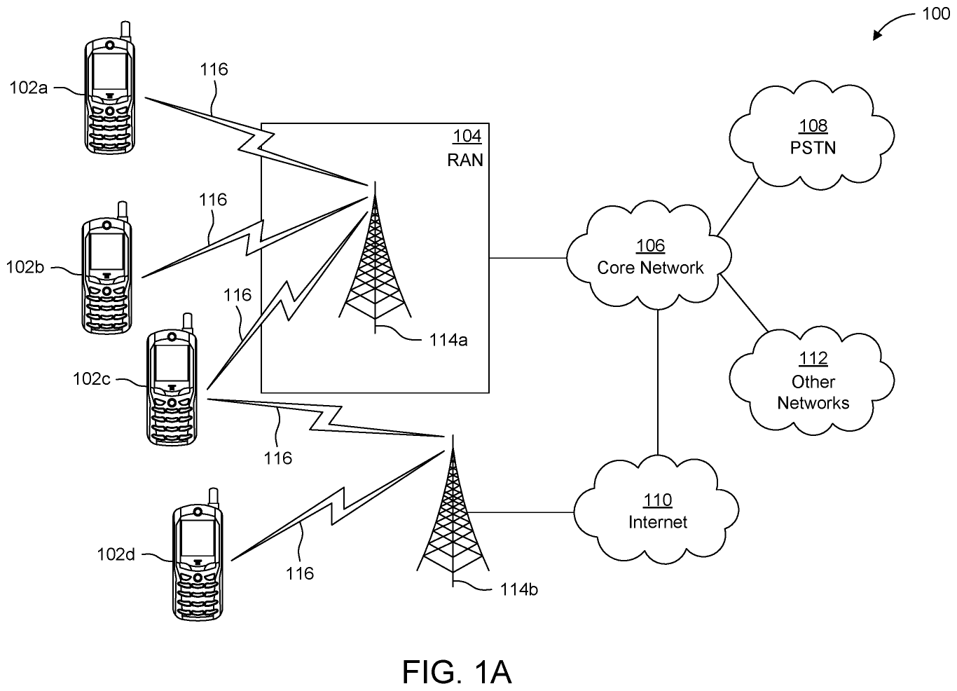

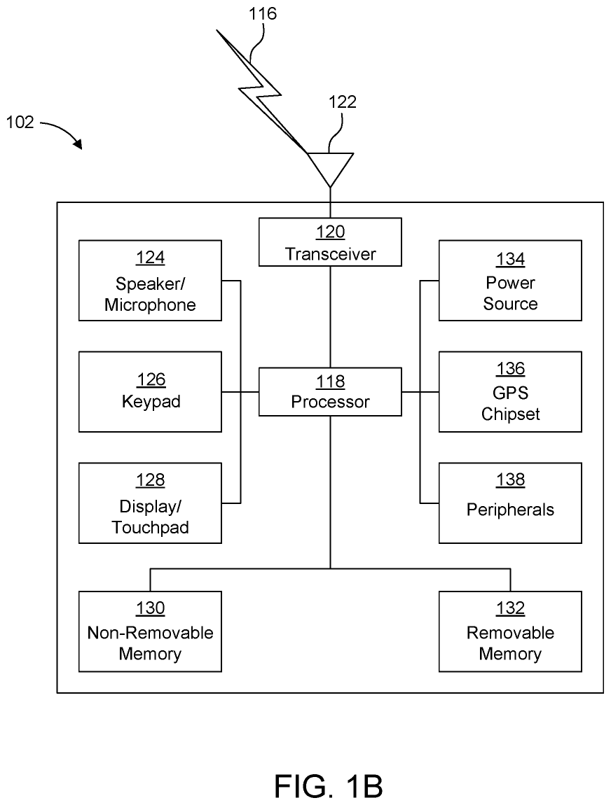

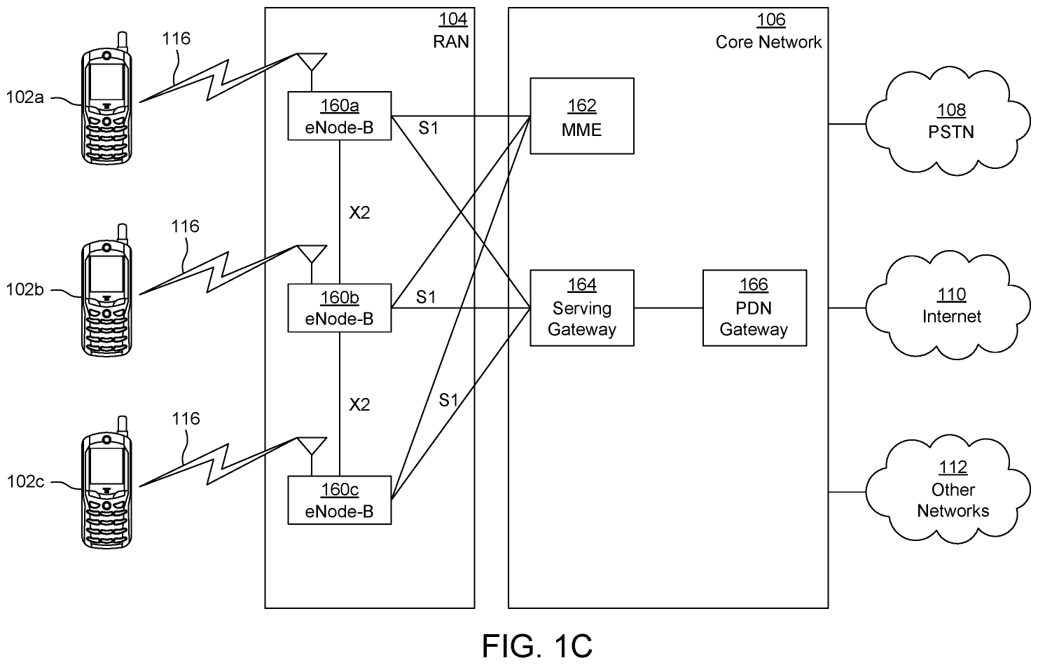

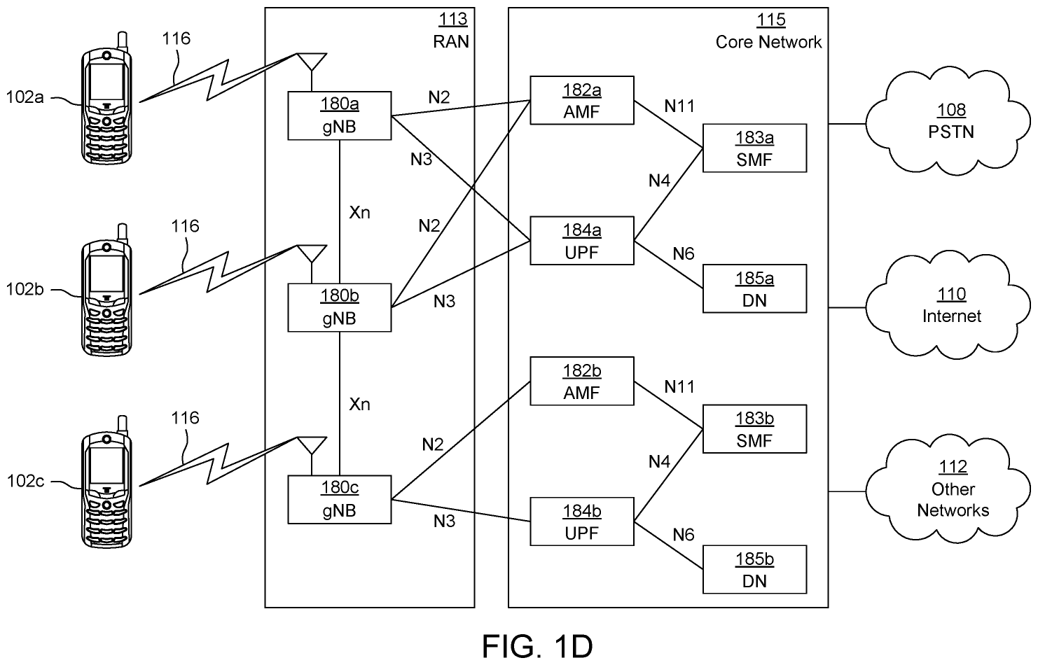

The methods, procedures, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHZ, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHZ, 4 MHZ, 8 MHZ, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using sub frame or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### INTRODUCTION

### Measurement Reporting

In 5G NR, there are two types of measurement reporting: periodical measurement reporting, and event-triggered measurement reporting. For periodical reports, a WTRU (or UE) is configured with a value from the following choice:
Reportinterval: =ENUMERATED {ms120, ms240, ms480, ms640, ms1024, ms2048, ms5120, ms 10240, ms20480, ms40960, min1, min6, min12, min30}

The WTRU sends periodical reports (e.g., to the network) with the configured periodicity. For event-triggered measurement reports, a WTRU is configured with certain measurement criteria that, once met, will trigger the generation of measurement reports. The event triggered reports can also be reported periodically, as long as the trigger conditions are fulfilled, and the event triggered reports may be based on a configured value, such as a ReportInterval value.

The reporting of measurements has an associated measurement type. In an example, for event-triggered measurements, thresholds are configured at a WTRU for comparison with measured results. If the measured results are higher (or lower) than one or more network (NW) configured thresholds, a measurement report is generated and/or triggered. Examples of measurement reporting events are: Event A1 (serving becomes better than threshold), Event A2 (serving becomes worse than threshold), Event A3 (neighbor becomes offset better than SpCell), Event A4 (neighbor becomes better than threshold), Event A5 (SpCell becomes worse than threshold1 and neighbor becomes better than threshold2), Event A6 (neighbor becomes offset better than SCell), Event B1 (inter RAT neighbor becomes better than threshold), Event B2 (PCell becomes worse than threshold1 and inter RAT neighbor becomes better than threshold2), Event 11 (interference becomes higher than threshold), Event C1 (the NR sidelink channel busy ratio is above a threshold), and/or Event C2 (the NR sidelink channel busy ratio is below a threshold).

### Coverage Holes and Weak Coverage Areas

In some current wireless communications networks, mobile devices (e.g., WTRUs) may experience two types of radio interface inefficiencies: 1) coverage holes, and/or 2) weak coverage spots. In an example, the definitions for the two concepts (i.e., two types of radio interface inefficiencies) come from 3GPP standards (e.g., 3GPP TS 37.320) as follows.

Coverage hole: A coverage hole is an area where the signal level signal-to-noise ratio (SNR) (or signal and interference-to-noise ratio (SINR)) of both serving and allowed neighbor cells is below the level needed to maintain basic service (SRB & DL common channels), i.e., coverage of PDCCH. Coverage holes are usually caused by physical obstructions such as new buildings, hills, or by unsuitable antenna parameters, or just inadequate RF planning. The WTRU (or UE) in coverage hole will suffer from call drop and radio link failure. Multi-band and/or Multi-RAT WTRUs may go to another network layer instead.

Weak coverage: Weak coverage occurs when the signal level SNR (or SINR) of serving cell is below the level needed to maintain a planned performance requirement (e.g., cell edge bit-rate).

The definition of coverage hole assumes that a WTRU (e.g., UE) does not have enough radio signal exposure from any cell, including serving and neighbor cells. The weak coverage definition implies that the SNR of the serving cell is low enough to cause service performance degradation, but not low enough to result in a radio link failure (RLF), and consequent service interruption.

Besides these two, TS 37.320 also provides some other relevant definitions, for example:

Pilot Pollution: In areas where coverage of different cells overlap a lot, interference levels are high, power levels are high, energy consumption is high and cell performance may be low. This problem phenomenon has been called “pilot pollution”, and the problem can be addressed by reducing coverage of cells. Typically in this situation, UEs may experience high SNR to more than one cell and high interference levels.

Overshoot coverage: Overshoot occurs when coverage of a cell reaches far beyond what is planned. It can occur as an “island” of coverage in the interior of another cell, which may not be a direct neighbor. Reasons for overshoot may be reflections in buildings or across open water, lakes etc. UEs in this area may suffer call drops or high interference. Possible actions to improve the situation include changing the coverage of certain cells and mobility blacklisting of certain cells.

Coverage mapping: There should be knowledge about the signal levels in the cell areas in order to get a complete view for the coverage and be able to assess the signal levels that can be provided in the network. This means that there should be measurements collected in all parts of the network, and not just in the areas where there are potential coverage issues.

UL coverage: Poor UL coverage might impact user experience in terms of call setup failure/call drop/poor UL voice quality. Therefore, coverage should be balanced between uplink and downlink connections. Possible UL coverage optimization comprises adapting the cellular coverage by changing the site configuration (antennas) but also about adjusting the UL related parameters in the way that they allow optimized usage of UL powers in different environments.

Cell boundary mapping: There should be knowledge about the location of (intra/inter RAT) cell boundaries in order to compare to the expected/planned network setting. Poor handover performance may be caused by changed cell boundaries due to changes in the physical condition of the surrounding area, e.g., construction of new buildings, bridge or tunnel near the handover area.

Coverage mapping for pico cell in CA scenario: As a realization of CA scenario 4 in TS 36.300, pico cell may be deployed in area where high traffic occurs. The location where a pico cell is available to be added as an SCell may show whether the deployment of pico cell is according to the needs of capacity increase.

From these definitions, two groups can be formed. Pilot Pollution and UL coverage form a first group of definitions that relate to poor service performance due to radio coverage and parameter mis-planning or high interference levels between cells. The UL coverage definition also considers call setup failures and drops, in some cases only poor UL performance is considered. The two definitions align well with the definition of weak coverage in the sense that they all relate to poor performance due to bad radio coverage.

A second group is formed, with Overshoot coverage, Coverage mapping, Cell boundary mapping, and Coverage mapping for pico cell in CA scenario being part of it. This second group shows the need and intention at 3GPP for NG-RAN nodes (and RAN in general) to understand the radio coverage of its cells.

### Overview

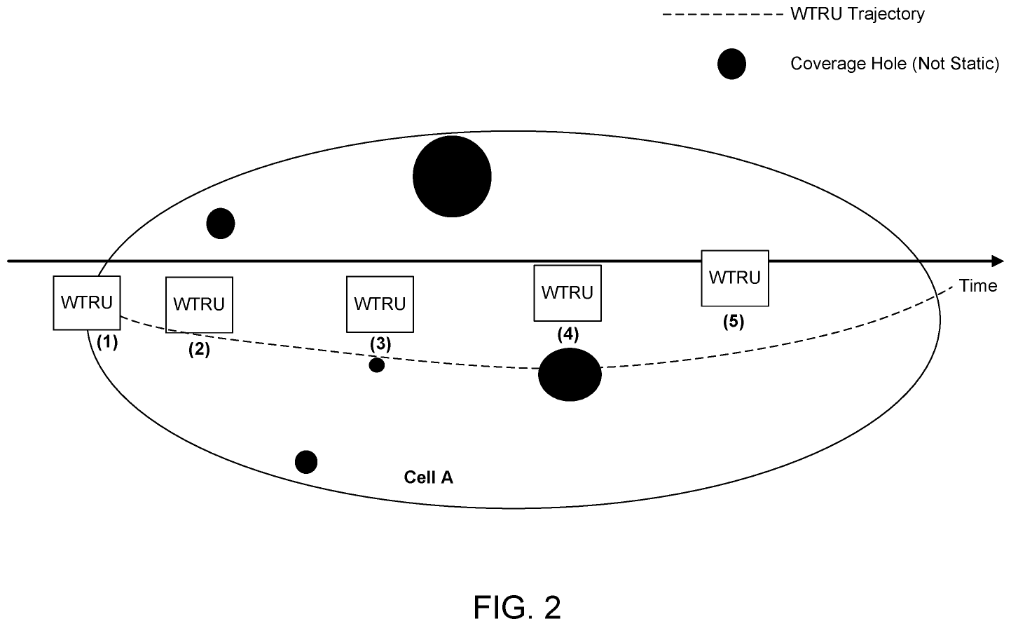

In some current implementations, mobile devices (e.g., WTRUs) may experience some radio interface inefficiencies, such as coverage holes and/or weak coverage spots. Referring to FIG. 2, an example illustrates a WTRU in mobility experiencing coverage holes and weak coverage spots. In this example, the WTRU (e.g., a UE) in mobility is in coverage of a cell A, with multiple timestamps (e.g., timestamps (1) to (5)) when relevant events happen in the moving path of the WTRU.

The WTRU trajectory has timestamps (1) to (5) as shown in FIG. 2, with relevant events happen:
1) The WTRU enters a cell A.
2) The WTRU receives a measurement configuration from the network. The configuration is sent via, for example, Radio Resource Control (RRC) Reconfiguration or RRCResume messages containing the MeasConfig object and its relevant parameters, which indicate or instruct the WTRU how to report measurements.
3) The WTRU continues in mobility and experiences a weak coverage spot during a subset of the time window presented in the FIG. 2. During this time, the WTRU has experienced service degradation.
4) The WTRU continues in mobility and experiences a coverage hole at this point, again during a subset of the time window presented in the FIG. 2. During this time, the WTRU has experienced a radio link failure (RLF). The coverage hole implies there is no coverage from any frequency band.
5) The WTRU continues in mobility and eventually leaves the cell A.

Still referring to FIG. 2, during this timeline of events discussed above, the WTRU may send measurement reports to the network. The measurement reports may be periodical and/or event-triggered.

In this example, the WTRU has experienced two major coverage problems: first, a weak coverage spot (timestamp/step (3)), and second, a coverage hole (timestamp/step (4)). These issues will lead to service degradation and failures, even if temporary. However, these issues could be avoidable, and may be addressed or solved by one or more embodiments disclosed herein.

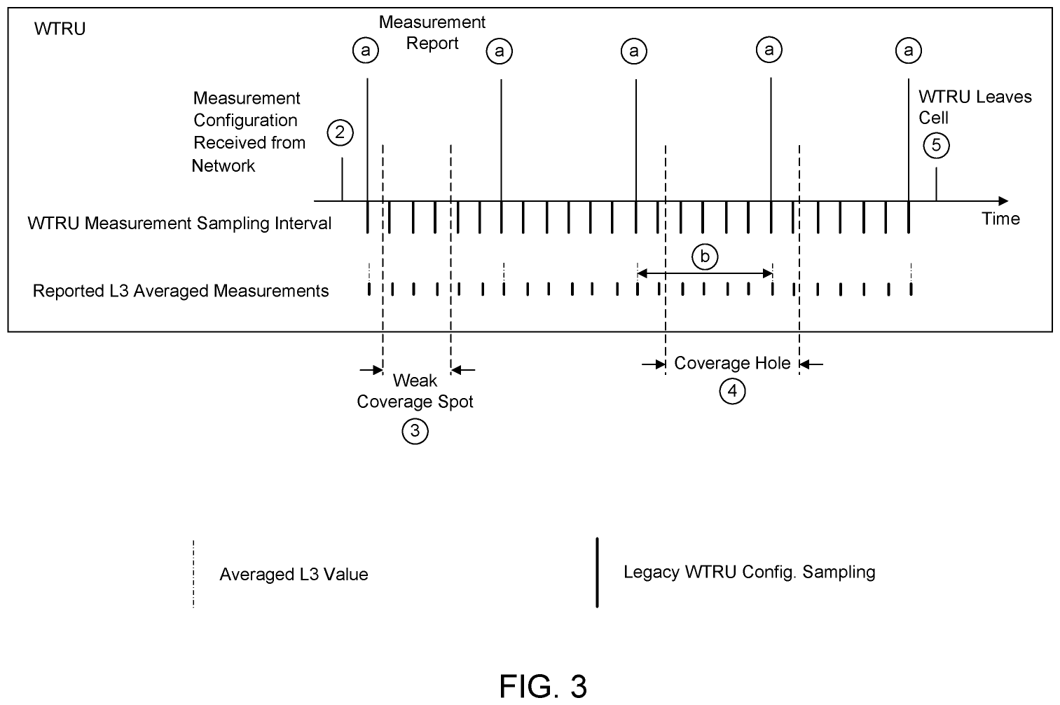

Referring to FIG. 3, an exemplary timeline with measurement reporting at a WTRU is provided. In this example, generation and reporting of measurements are illustrated in detail (as shown in FIG. 3). In step 2, the WTRU receives (or obtain, or determine) a measurement configuration (and/or indication) detailing how to perform measurements and how to report them. In step 3, the WTRU experiences poor coverage (e.g., a weak coverage spot), and in step 4, the WTRU experiences a coverage hole. In step 5, the WTRU leaves the cell. During these steps (e.g., steps 2-5), a series of measurement reports (measurement report (a)) are sent to the NG-RAN node (according to the received configuration in step 2). Finally, a set of lines denotes the WTRU sampling of the air interface as instructed in step 2, and Layer 3 (L3) averaged values as shown FIG. 3. In an example, one or more of the L3 averaged values are the value(s) sent in a measurement report when the reporting conditions are fulfilled, and is the averaging of the legacy sampling points with solid lines in period (b)). In this example, the WTRU applies a L3 filtering that takes the mean/average of the previous six sampled values for a specific measurement quantity (e.g., any of: Reference Signal Received Power (RSRP), Reference Signal Received Quality (RSRQ), and/or Signal and Interference to Noise ratio (SINR)) for cell and beam measurements, and RS-RSRP or cross-link interference (CLI)-Received Signal Strength Indicator (RSSI) for CLI measurements).

A third problem is therefore identified. After experiencing either the weak coverage spot or the coverage hole, the WTRU sends a measurement report (e.g., if the triggering conditions are fulfilled) that contains averaged value(s) of performed measurements to the network. As depicted, the WTRU has useful radio data collection abilities (by having smaller sampling periodicity) that are not leveraged due to L3 filtering, therefore the network (e.g., RAN) may never get all the enough measurement data to understand where exactly coverage problems are (e.g., due to the loss of granularity of the L3 filtering). In addition, there is only one measurement result (e.g., the last L3 filtered measurement when the measurement reporting trigger conditions are fulfilled) being included for a respective measured serving/neighbor cell. If the report generation is periodic, instead of event triggered, the problem becomes even more pronounced as the reporting period can only match a coverage hole or weak coverage spot by mere chance as the radio conditions are prone to changes.

Both periodic and event-based measurement reporting have an associated measurement reporting configuration. This configuration relies on threshold(s) associated with one or more specific events (e.g., any of events A1-A6 or events B1-B2). In some examples, a WTRU may be triggered to send measurement reports to the network, either in a periodic way or when one or more events occur (event-triggered). In case of event-triggered measurement reporting, the WTRU may are configured, for a given cell (e.g., a serving cell or a neighbor cell), with event(s) (e.g., events A1-A6 for serving cells and/or intra-RAT neighbor cells, and/or events B1-B2 for inter-RAT neighbor cell measurements, such as LTE measurements). In an example of event A2 (serving cell becomes worse than threshold), when a WTRU is configured to trigger measurement reporting with an event A2 for a serving cell, the network also configures the WTRU with a threshold for a radio quantity (e.g., RSRP). In this example, if the L3 averaged value (e.g., L3 averaged RSRP value) is below the configured threshold (e.g., RSRP threshold) for the serving cell for (or during) a specified Time to Trigger (TTT), the WTRU sends one or more measurement reports to the network. Current implementations do not provide similar event(s) for neighbor cells.

These current events are designed mainly for cell edge evaluation for WTRU mobility across cells. Therefore, a fourth problem is identified: the event-based measurement reporting may mislead the network to assume the WTRU is at a cell edge or, especially in the weak coverage case, the WTRU may sample some measurements under or above configured measurement thresholds. However, because these samples are then averaged, the averaged value may not be enough to trigger the reporting of measurements. This situation results in the network not being aware of some of its coverage problems.

The identified problems can be summarized as the inability for the network to have a detailed database of measurements that can be very useful for identifying coverage problems and to avoid QoS violations and RLFs.

### Representative Procedures for Measurement Collection and Reporting

In various embodiments, enhanced procedures for measurement data collection and measurement reporting are provided. For example, some enhancements address weak coverage spot detection, where the weak coverage spot can potentially lead to the WTRU experiencing a coverage hole. In some examples, methods and procedures for storage of augmented measurements and/or reporting of those measurements are provided.

In one embodiment, a WTRU is configured to report augmented measurements, in addition (or not) to current L3 measurements, where the WTRU can be configured for measurement collection when any of the following has been triggered: the WTRU starts collection based on self-detected sub-optimal QoS and coverage experience on a serving cell; the WTRU starts collection based on WTRU detected sub-optimal coverage experience on neighbor cells via new events; and/or the WTRU starts collection based on different types of NW configured windows on any cell.

In one embodiment, the configuration (that includes new parameters) may be sent from the NW to the WTRU replacing the current specification's measurement reporting or, in addition (as a parallel configuration) to the current specification's measurement reporting.

In one embodiment, the WTRU may perform (e.g., optionally) autonomous filtering of augmented measurements.

In one embodiment, the WTRU may perform a scan of the air interface for 3GPP and non-3GPP radio access technologies (e.g., a snapshot of measurements), in the event of a coverage hole experience, and reporting the collected snapshot after connection re-establishment.

### Triggering of Detailed Measurement Storage for Insufficient Coverage Detection

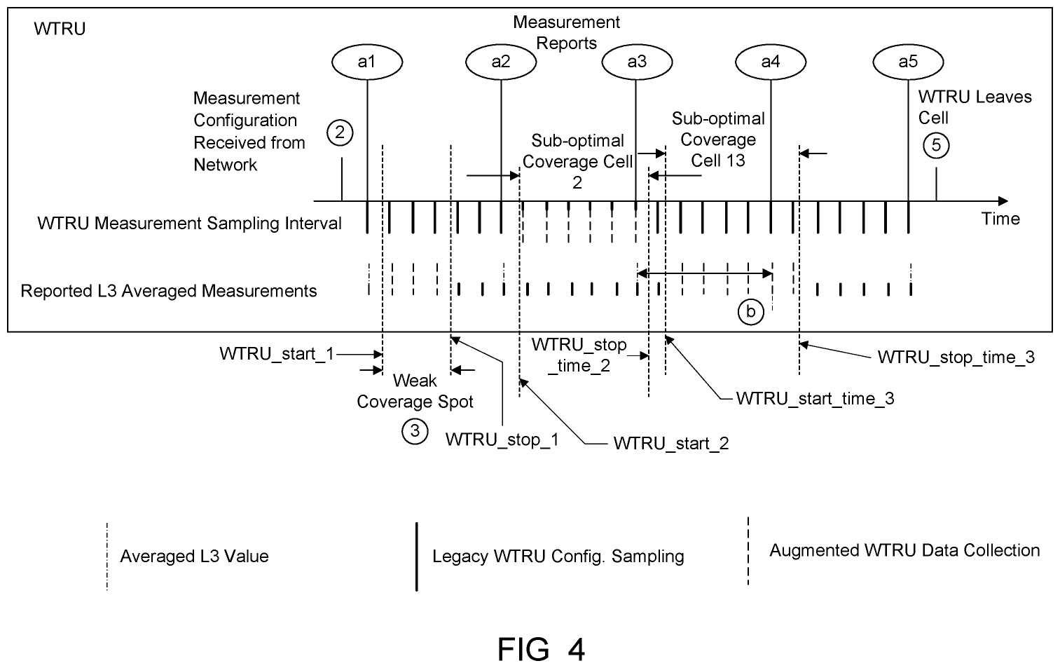

In some current implementations, a WTRU receives a measurement configuration, with a list of cells which the WTRU is supposed to monitor for. The WTRU receives, within a measurement configuration, measurement report triggering conditions for either cells or beams, which could be any combination of thresholds based on RSRP, RSRQ, or SINR. When the reporting conditions are fulfilled (e.g., reporting interval has elapsed or the serving cells or neighbor cells have fulfilled the associated trigger conditions), the WTRU sends the last L3 averaged value of RSRP, RSRQ, and/or SINR for each cell that is being measured, as shown in FIG. 4.

As per its definition, a weak coverage area does not lead to an RLF, but it can result in service degradation. This can be detected by the WTRU (e.g., a WTRU can detect if the QoS requirements for its active bearers such as data rate, packet error rate, or latency, are being met). These parameters can be consulted in Table 5.7.4-1: Standardized 5QI to QoS characteristics mapping in 3GPP TS 23.501-System architecture for the 5G System (5GS). And the thresholds configured for measurement reporting (e.g. in the measurement event(s) A1-A6 configurations) may not be met, while the current QoS of the WTRU's active bearers are not being met.

In various embodiments discussed below, configuration information (or indications) may be sent (e.g., from the network, gNB, or eNB) to WTRU(s) as a main measurement configuration. In some examples, the configuration information may be sent as a second and/or parallel configuration, and may be exclusively dedicated to sub-optimal coverage reporting.

### Measurement Triggering on Serving Cell—WTRU Starts Collection Based on WTRU Detected Sub-Optimal QoS/Coverage Experience

In one embodiment, a WTRU may be configured to store measurement results during the periods or intervals where the QoS of its bearers are not being met. The WTRU may be configured to consider the QoS of its bearers being not fulfilled if, for example, at least one bearer is failing to meet the QoS requirement, or all the bearers are failing to meet their QoS requirements, or a certain (configured) subset of the bearers is configured to meet their QoS requirements, or the highest priority bearer is failing to meet its QoS requirement, or any bearer of a certain (configured) QoS class is failing to meet QoS requirements, or all the bearers of a certain (configured) QoS class are failing to meet their QoS requirements.

In one embodiment, the storing (or buffering) of the measurements is triggered when: 1) the QoS conditions discussed above are fulfilled, and/or 2) at least one of the measurement samples (e.g., legacy sampling points with solid lines in FIG. 4) meets one or more measurement reporting trigger thresholds. In some examples, the storing (or buffering) of the measurements may include storing a set of variables (and/or parameters). In some current measurement reporting methods, the measurement reporting trigger thresholds have to be fulfilled, as compared to the L3 filtered measurements, for a certain duration (e.g., time to trigger (TTT)) before the conditions are considered to be fulfilled. As an enhancement to the current measurement reporting, if the QoS of the bearers is not being fulfilled for one or more of the bearers according to any of the embodiments discussed herein, the WTRU may further consider the instantaneous measurements (e.g., the latest sample value, the latest L3 filtered value) and compare them with the thresholds(s) associated with the configured measurement event(s). In an example, if the conditions are fulfilled, the WTRU considers the detailed measurement gathering triggering conditions are fulfilled and will start storing the detailed measurements (e.g., without the need to wait for the TTT to be fulfilled). The enhancement covers measurement collection on serving cell(s). In some cases, the WTRU may lose connectivity to the serving cell, however, this situation may not imply, by definition, that the WTRU is experiencing a coverage hole.

### Measurement Triggering on Neighbor Cells—WTRU Starts Collection Based on WTRU Detected Sub-Optimal Coverage Experience

In one embodiment, for neighbor cells, new measurement events are defined and may be used to trigger the starting of detailed measurements. Some examples of these new events (e.g., event Au, event Av, event Aw, and/or event Ax) are listed below:
event Au: neighbor cell becomes worse than a threshold;
event Av: neighbor cell becomes worse than a certain threshold and serving cell becomes worse than a certain threshold;
event Aw: all neighbor cells become worse than a certain threshold; and/or
event Ax: all neighbor cells become worse than a certain threshold and serving cell becomes worse than a certain threshold;

For inter-RAT measurements, new measurement events are defined and may be used to trigger the starting of detailed measurements. Some examples of these new inter-RAT events (e.g., event Bu, event Bv, event Bw, event Bx, and/or event By) are listed below:
event Bu: inter-RAT neighbor cell becomes worse than a threshold;
event Bv: inter-RAT neighbor cell becomes worse than a certain threshold and serving cell becomes worse than a certain threshold;
event Bw: all inter-RAT neighbor cells become worse than a certain threshold;
event Bx: all inter-RAT neighbor cells become worse than a certain threshold and serving cell becomes worse than a certain threshold; and/or
event By: inter-RAT neighbor cell becomes worse than a certain threshold and serving cell becomes better than a certain threshold.

In an example, configuration of these events (e.g., in the WTRU) may be sent/indicated (e.g., from the NW) to the WTRU as regular measurement configuration. In another example, configuration of these events may be sent/indicated (e.g., from the NW) to the WTRU as a second (or parallel) configuration in relation to the current system. For instance, the WTRU may be configured with the enhanced procedures/methods discussed above (e.g., the measurement collection and triggering on a serving cell). In another example, the WTRU may have (e.g., be configured with) a second measurement criteria for the purposes of enhanced data collection, while doing its routine measurements.

### Measurement Triggering on any Cell—WTRU Starts Collection Based on Specific NW Configuration

The network may have some initial/approximate knowledge or information about the location of coverage holes and weak coverage spots. In an example, this information may come (e.g., obtained or determined) from a geolocation database that was built earlier (e.g., the measurement collection and triggering on a serving cell and/or a neighbor cell as discussed above). In another example, this information may be obtained, determined, or derived from any other source(s) of information or indication (e.g., from the network).

In some examples, the assumption of the coverage mapping knowledge by the network implies immediately that, if the WTRU trajectory is known to the network, the network may be able to predict whether a WTRU will experience non-optimal coverage.

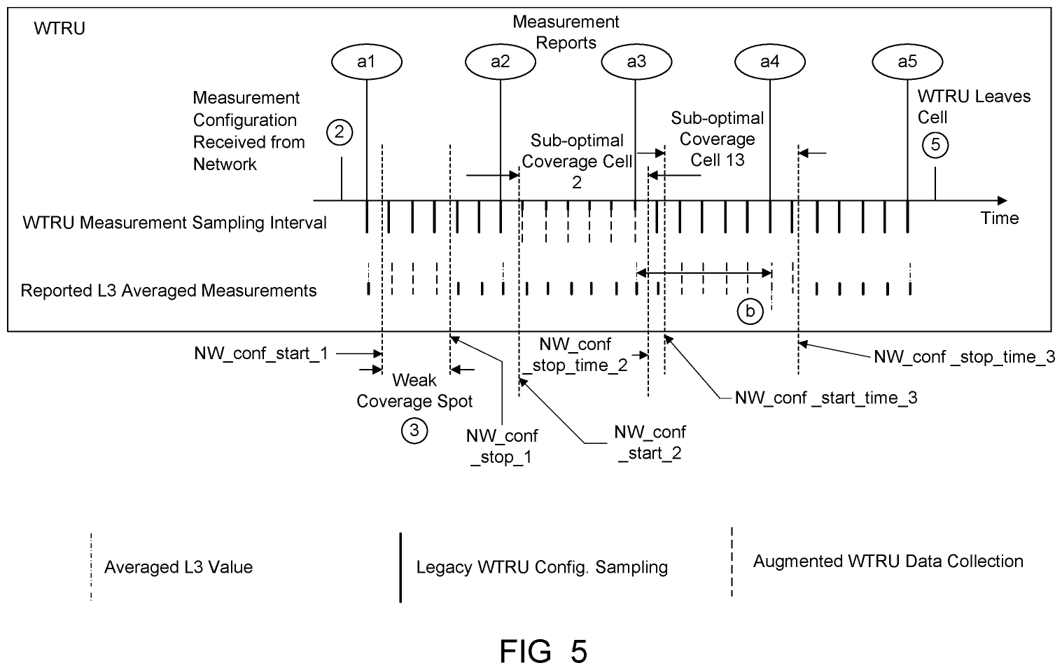

In one embodiment, referring to FIG. 5, the network may configure the WTRU with a time window (e.g., a start time/point and a stop time/point) corresponding to the time (or others, explained below) durations that the WTRU is expected to experience non-optimal coverage. The network may specify a start time that is a bit earlier or later than the expected time where the WTRU is expected to start experiencing non-optimal coverage. Similarly, the end time may be specified (e.g., by the network) to be later or earlier than the WTRU is expected to start experiencing normal coverage again.

In an example, FIG. 5 shows how the network can provide the WTRU a window configuration. The highlighted windows start and stop points (NW_conf_start_1; NW_conf_stop_1), (NW_conf_start_2; NW_conf_stop_2) and (NW_conf_start_3; NW_conf_stop_3) represent these windows. These windows may be represented by any of: a time, a geo-location, a physical distance, an amount of UP UL data, an amount of UP DL data, an amount of augmented measurements data, and/or any combination of the above. For example, a time window may be configured as (NW_conf_start_time_1; NW_conf_stop_time_1) or (NW_conf_start_time_2; NW_conf_stop_time_2).

In one embodiment, alternatively or in addition to the time information/configuration, the WTRU may be configured with location information where to collect or provide more or enhanced measurements. For example, the WTRU may be configured with a set of location-based windows and may record more sampled measurements while in those locations. This can be achieved by the network sending the parameters (NW_conf_start_geo_1; NW_conf_stop_geo_1) and (NW_conf_start_geo_2; NW_conf_stop_geo_2), as shown in the example in FIG. 5, and these would replace (NW_conf_start_time_1; NW_conf_stop_time_1).

The WTRU may also be configured with a combination of time and location windows. For example, a WTRU may be configured with a start time for the interval (NW_conf_start_time_1) and a stop distance (NW_conf_stop_distance_1), specifying the WTRU will collect more measurements from the specified start time until it has traversed the specified distance. As another example, the WTRU may be configured with a start location (NW_conf_stop_geo_1) and a stop time (NW_conf_stop_duration_1), specifying that the WTRU will collect more measurements from the specified start location for the specified duration.

In various embodiments, this mixed configuration may be associated with an amount of data. The amount of data can relate to an amount of UP data that the WTRU needs to upload to the network, an amount of data the WTRU needs to receive in the DL, or an amount of augmented measurements (AM) data. The WTRU can be configured as well with, as an example, a start time for the interval (NW_conf_start_time_1) and a stop UP data amount, which can relate to the uplink or the downlink (NW_conf_stop_data_UL_1 or NW_conf_stop_data_DL_1). Another example would be a start geo-location (NW_conf_stop_geo_1) and a stop time that is (NW_conf_stop_data_AM_1). In some cases, after this amount of data is transmitted or received by the WTRU, respectively, the WTRU would automatically know the detailed measurement data collection process should stop.

In one embodiment, in order for this configuration to be properly set, the WTRU may be configured to provide (or expected to provide) WTRU trajectory information to the network.

In another embodiment, the WTRU may pause or stop the storing of the detailed measurements (e.g., based on any of the embodiments discussed above), when the conditions for collecting the measurements (e.g., based on any of the embodiments discussed above) are not fulfilled anymore. Similarly, the WTRU may restart or resume the storing of the detailed measurements when any of the conditions for storing the (e.g., detailed) measurements (e.g., according to any of the embodiments discussed above) is fulfilled.

### Information Included in the Detailed Measurements

In one embodiment, the WTRU is configured to store only the L3 averaged values during the time the detailed measurement gathering conditions are fulfilled.

In one embodiment, the WTRU is configured to store all the individual measurement samples (e.g., non-filtered) during these detailed measurement gathering intervals.

In one embodiment, the WTRU is configured to store the measurements (individual samples and/or L3 averages) for all measured cells.

In one embodiment, the WTRU is configured to store the measurements (e.g., individual samples and/or L3 averages) in different ways for different cells. For example, individual samples for serving cells but only L3 averages for neighbor cells, or individual samples for neighbor cells but only L3 averages for serving cells, or individual samples for a subset of preconfigured cells but L3 averages for the other cells, or individual samples for cells of a certain frequency while L3 averages for cells of other frequency, or individual samples for cells of a certain technology (e.g., 5G NR), but only L3 averages for cells of other technology (e.g., LTE).

In one embodiment, the WTRU may be configured to include time information for the detailed measurements that it is storing, for example: a timestamp for each measurement sample stored; a start timestamp corresponding to the start of the detailed measurement (e.g., [t1_start, measurements taken during first interval], [t2_start, measurements taken during second interval, etc.,); a start and end timestamp corresponding to the start/pausing of the detailed measurement (e.g., [t1_start, t1_end, measurements taken during first interval], [t2_start, t2_end, measurements taken during second interval], etc.,); and/or a start timestamp corresponding to the start of the detailed measurements, and a delta value for each subsequent sample.

In one embodiment, the WTRU may be configured to include location information (e.g., GNSS coordinates) for the detailed measurements that it is storing, for example: a location coordinate for each measurement sample stored; a start location coordinate corresponding to the start of the detailed measurement (e.g., [L1_start, measurements taken during first interval], [L2_start, measurements taken during second interval, etc.,); a start and end location coordinates corresponding to the start/pausing of the detailed measurement (e.g., [L1_start, L1_end, measurements taken during first interval], [L2_start, L2_end, measurements taken during second interval], etc.,); and/or a start location coordinate corresponding to the start of the detailed measurements, and a delta value for each subsequent sample.

In one embodiment, the WTRU may be configured to store a certain number of measurements, and the amount can be specified in any or a combination of the following: 1) when the size of the measurement report reaches a certain amount (e.g. × MBs), 2) when the amount of time elapsed between the first measurement in the measurement report and the last measurement report is above a certain threshold (e.g. × minutes), 3) when the WTRU has paused and resumed the storing of the detailed measurements as certain number of times (e.g., 5 times), 4) when the amount of UP UL data reaches a certain amount (e.g. × MBs), and/or 5) when the amount of UP DL data reaches a certain amount (e.g. × MBs).

In one embodiment, the WTRU may be configured to override (or replace) older measurements with newer measurements upon certain conditions (e.g., to maintain the total measurement report size within a given MBs, to maintain the time difference between the oldest and the newest measurements to be within a certain limit, and/or to maintain the location difference between the oldest and the newest measurements to be within a certain limit, etc.,)

### Autonomous WTRU Filtering of Augmented Measurements

Referring to FIG. 5, if the network configures the WTRU with thresholds within an event Au listed above, for cells 2 and 13, the WTRU may proceed with sampling the configured quantities as per the legacy sampling points with solid lines in FIG. 5. In an example, three outcomes are envisioned (as an example if the threshold is a minimum threshold but would work in the same way for a maximum threshold):
i) The L3 filtering result is bigger than the configured threshold;
j) The L3 filtering result is smaller than the configured threshold. However, one or more samples were bigger than the configured threshold;
k) The L3 filtering result is smaller than the configured threshold, as well as all samples collected.

In the case of i), it is clear the criteria was not met so no need for the WTRU to store and report augmented measurements. The WTRU shall then report only the result of the L3 averaging process. In the cases of j) and k), however, the criteria have been met. If the outcome of this process is j), then some (but not all) samples were under the configured threshold. In an example, the WTRU may report 1) the samples that were under (or below) the threshold and 2) the result of the L3 averaging process (e.g., a L3 averaged value). This would provide to the network (from the WTRU) an implicit but a clear indication that some samples were under the configured threshold. This would be a WTRU filtering mechanism for the number of samples that the WTRU could have in an effort to reduce the amount of data that needs to be included in the reports. In case the outcome is k) however, the WTRU could report all the samples as they were all smaller than the configured threshold.

In an example, the configuration discussed above may be sent to the WTRU, e.g., based on a network decision, via a flag to instruct the WTRU to perform autonomously filtering (e.g., to filter augmented measurements, or measurement results, or samples). In another example, the configuration discussed above may not be sent to the WTRU (e.g., based on a network decision), and may be indicated to the WTRU via a flag to instruct the WTRU to perform autonomously filtering (e.g., to filter augmented measurements, or measurement results, or samples).

### Reporting of the Detailed Measurements

In one embodiment, the WTRU may be configured to send the availability of the detailed measurements to the network (e.g., by sending a WTRU Assistance Information message that indicates the availability of the measurements, by including a flag on RRC complete messages such RRC Reconfiguration complete, by including a flag on legacy measurement reports that were sent when the trigger conditions for legacy A1-A6 events are fulfilled, by including a flag on legacy RLF report, when the network explicitly asks for the availability of detailed measurement information, etc.,).

In one embodiment, the WTRU may be configured to include additional information about the detailed information, instead of just indicating their availability (e.g. size, time duration span from the oldest to the newest measurements, location span of all the measurements stored, etc.)

In one embodiment, the WTRU may be configured to trigger the sending of the detailed measurements when a certain number of measurements have been collected, where the amount can be specified in any or a combination of the following: 1) when the size of the measurement report reaches a certain amount (e.g. × MBs), 2) when the amount of time elapsed between the first measurement in the measurement report and the last measurement report is above a certain threshold (e.g. × minutes), and/or 3) when the WTRU has paused and resumed the storing of the detailed measurements as certain number of times (e.g., 5 times).

In one embodiment, the WTRU may be configured to include the detailed measurements in the next opportunity that it gets to send measurements, according to one or more measurement triggering conditions (e.g., when the trigger conditions for legacy A1-A6 events are fulfilled).

In one embodiment, the NW can instruct the WTRU to send the collected measurements in one or more measurement reports, specified by a clear measurement report number (e.g., as shown as a1-a5 in FIG. 5), a number such as a countdown in terms of measurement reports (works for periodic or event-based measurement reporting), a countdown timer or timers for specific measurement reports (in case of periodic reporting), or any other form of indication.

In one embodiment, the network may request the WTRU to send a subset of the available measurements (e.g., only a certain subset of cells, only measurements taken within a certain time or/and location interval, only the first n number of measurements, only the last n number of measurements, only the first set (or × MB) of measurements, only the last set (or y MB) of measurements, etc.)

In one embodiment, the WTRU may be configured to send the measurements split into several measurement reports. For example, the WTRU may include only the measurements that fit in the amount of UL resources granted for sending the measurements (e.g., after the reception of a request from the network to send the measurements). The WTRU may additionally include information (e.g., a flag in the measurement report) if all the measurements are sent or if there are remaining measurements. For example, if the total stored measurements are 3MBs in size and the WTRU was provided only a grant that is able to carry 1 MB of measurements, it may send the first 1 MB of the measurements and includes a flag indicating more measurements are still available (or additionally, information regarding how much measurement data, in terms of MBs, is pending to be sent, for example). If an UL grant that is able to carry the rest of the measurements is given to the WTRU afterwards, the WTRU will send all the remaining measurements and includes an indication that no further measurements are available.

In one embodiment, the WTRU may be configured to prioritize the sending of DRB data over the detailed measurement reports. This is in contrast to normal measurement reporting, where the reporting is done via signaling radio bearers (e.g., SRB1, SRB2) that have higher priority than any DRB. Since the detailed measurement reports are not immediately needed for the handover/mobility of that UE, but rather to gather detailed information about possible coverage issues in the network, there may not be a need to prioritize these measurement reports over data radio bearers. Also, as the detailed measurements could be of considerable size, prioritizing the sending of these measurements over DRBs may cause UL service interruption for the DRBs (i.e., while the measurements are being sent).

In various embodiments, deprioritizing sending of the detailed measurements as compared DRBs may be accomplished in several ways. For example, a new SRB is introduced for sending these detailed measurements, where this SRB has a lower priority than some or all of the DRBs. In another example, the WTRU may be configured with a “pseudo” DRB, that is used to send the detailed measurements. In an example, the WTRU may be configured to use normal measurement reporting prioritization (e.g., SRB1) if the size of the measurement report is below a certain level (e.g., × MBs), but use the above (either a lower priority SRB or even a DRB) when the size is above a certain level. In another example, the WTRU may be configured to use normal measurement reporting prioritization (e.g., SRB1) to send up to a certain amount (e.g., × MBs) of measurement report, but use the above (either a lower priority SRB or even a DRB) for the remaining measurements.

Reporting of an Air Interface Snapshot when a Coverage Hole is Experienced by WTRU

The embodiments discussed above provide means for the WTRU to detect, store and report augmented measurements while experiencing sub-optimal coverage on serving and neighbor cells. It is possible that the WTRU experiences coverage conditions' degradation in such a way that none of the allowed cells in the allowed cell list configured by the NW for measurements is able to provide connectivity (coverage of Physical Downlink Control Channel (PDCCH)). If this happens, the WTRU can perform at least single sampling measurements related to any 3GPP or non-3GPP Radio Access technology, according to the current specification for antenna port signal sampling.

In one embodiment, the WTRU may be configured by the network to collect these measurements. In another embodiment, the WTRU may be configured by the network to not (e.g., skip, or delay) collect these measurements (e.g., via absence of configuration).

The measurements list may include any of the following: any 5G NR cell/beam frequency currently not in the allowed cell list; a frequency range for cells/beams; a set of 5G NR measurements for the WTRU to collect (e.g. RSRP, RSRQ, SINR or a combination of these); any 3GPP cell frequency currently not in the allowed cell list; a set of 3GPP but non-5G measurements for the WTRU to collect (e.g. RSRP, RSRQ, EcNO, etc. or a combination of these); a frequency range for Wi-Fi (e.g., 2.4 GHZ, or 5 GHZ, or both); a set of Wi-Fi related measurements; a frequency range for Bluetooth; a set of Bluetooth related measurements; a frequency range for Li-Fi; and/or a set of Li-Fi related measurements.

### Example Configurations, Procedures, and Flow Charts

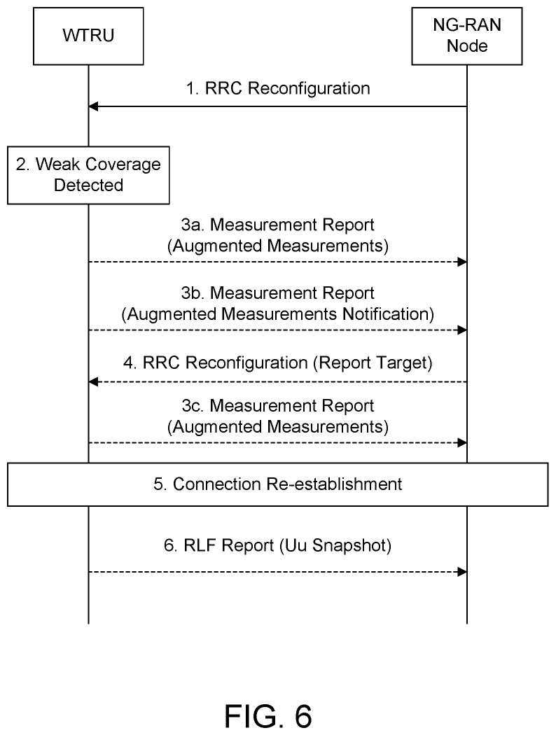

FIG. 6 illustrates an example procedure for the proposed triggering of measurement collection and reporting in one or more embodiments discussed above.

In an example as shown in FIG. 6, the example procedure may include any of the following operations/steps:
1—The network (e.g., a gNB) sends an RRC Reconfiguration message (or any other message) to the WTRU, the message includes configuration information that configures the WTRU with the relevant parameters for measurement reporting (e.g., in “Measurement triggering on serving cell”, “Measurement triggering on neighbor cells”, and/or “Measurement triggering on any cell”);
2—The WTRU detects a weak coverage area in any of the serving or neighbor cells, and the WTRU performs the augmented/detailed measurement gathering/storage;
3-3a. the WTRU sends the augmented measurements in case that was the NW's decision in step 1. 3b. the WTRU sends a notification to the NW that augmented measurements are available. In this case, the WTRU will signal what is presented in “Reporting of the detailed measurements”:
4—If the WTRU option is 3b., the NW may use the RRC reconfiguration message (or any other message) to indicate (e.g., via a flag) the WTRU which report it should target, according to “Reporting of the detailed measurements”.
   3c. If the NW used step 4 to inform/indicate the WTRU of when to send the augmented measurements, then the WTRU may report the augmented measurements. This process may be executed in several messages as detailed in “Reporting of the detailed measurements”.
5—After declaring RLF, the WTRU is able to re-establish connection to any cell.
6—A coverage hole and subsequent RLF can occur at any point in time. The WTRU behavior can then be to perform any measurements as explained in “Reporting of an air interface snapshot when a coverage hole is experienced by WIRU”, and deliver that “air interface (Uu) snapshot” to the network via a RLF report, or any other message.

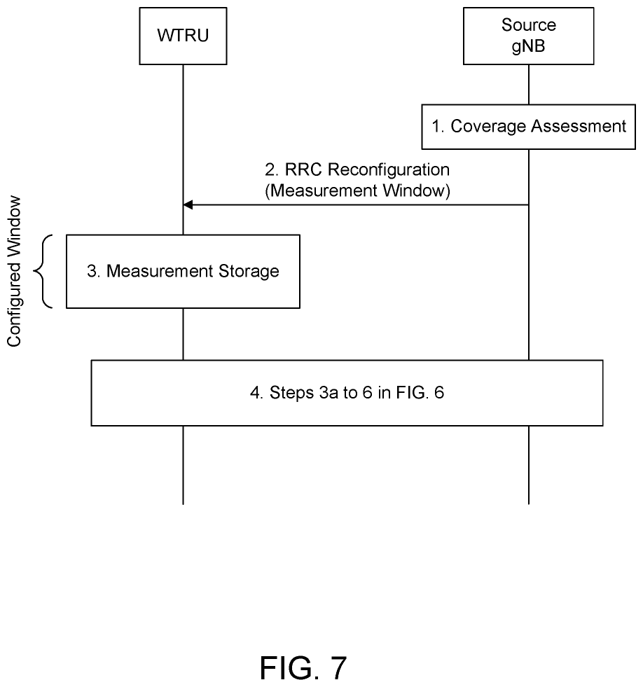

FIG. 7 illustrates another example procedure for the proposed triggering of measurement collection and reporting in one or more embodiments discussed above. As shown in FIG. 7, the example procedure may include any of the following operations/steps:
1—Based on all the information it has available on its coverage database (DB) and possibly including any trajectory prediction or assessment that it may have available, the source NG-RAN node can now configure the WTRU with detailed measurement interval windows (time, location, etc.) wherein the WTRU will gather detailed/augmented measurements.
2—The NW may instruct the WTRU with the windows for augmented measurement collection, as detailed in “Measurement triggering on any cell”. The remaining configuration detailed in one or more embodiments discussed above may also be transmitted to the WTRU, e.g., via an RRC reconfiguration message (or any other message).
3—The WTRU may store the measurements (e.g., according to one or more embodiments discussed above) during the configured interval windows.
4—When/after the WTRU has collected the detailed measurements, steps 3a. to 6 in FIG. 6 may apply.

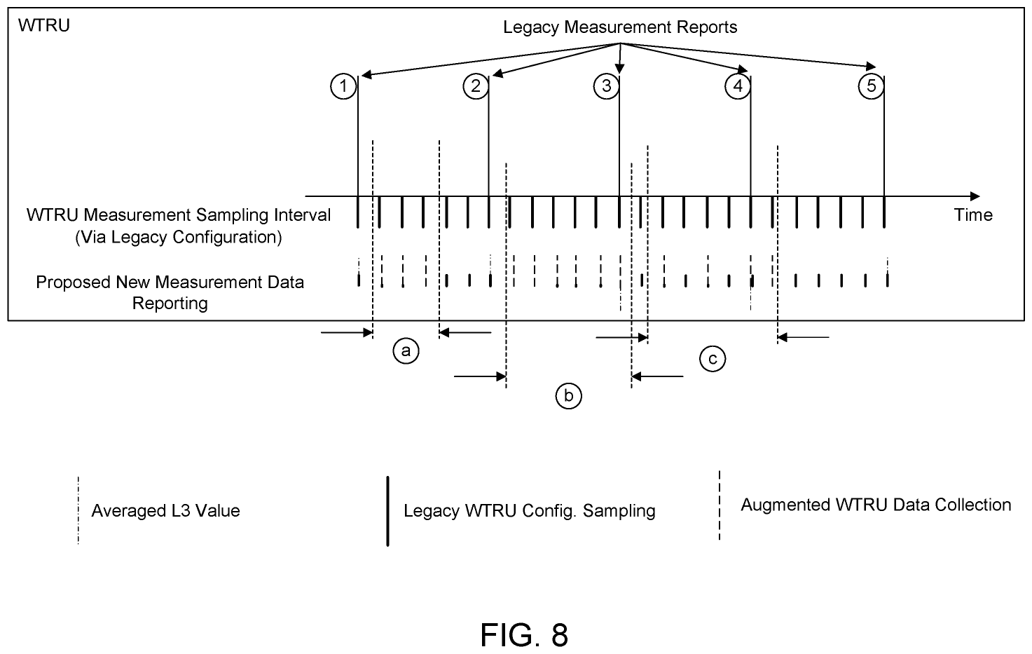

In one embodiment, referring to FIG. 8, a WTRU is configured to perform measurement data collection and reporting using an enhanced measurement reporting method. For example, in a time window (a) as shown in FIG. 8, when the WTRU detects a QoS violation and/or a weak coverage on a serving cell, the WTRU may store all the samples while QoS violation condition is active, and report at timestamp (2) (or (3), (4), (5) with or without L3 legacy sampling values. In another example, the WTRU in a time window (b) may start new measurement data collection based on a direct network instruction/indication (e.g., from a serving cell or a neighboring cell). The WTRU may store all samples while the network instruction is valid, or the WTRU may store a few (not all) samples instead. The WTRU may send measurement report(s) at timestamp (4) and/or timestamp (5), with or without L3 legacy sampling values. In yet another example, the WTRU in a time window (c) may detect a new triggering event (e.g., event Au: neighbor cell becomes worse than a threshold), and the WTRU may store only samples lower than the Au event threshold (may also store all samples). The WTRU may send measurement report(s) at timestamp (5) with or without L3 legacy sampling values.

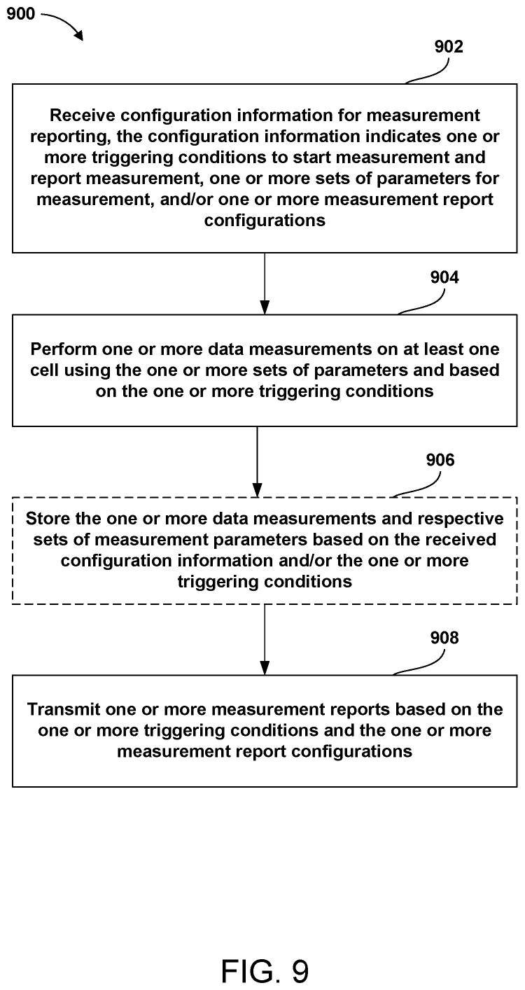

In one embodiment, to enhance the air interface data collection process, a WTRU (e.g., WTRU 102 in FIG. 1B) is configured (e.g., by the network) to collect and report more detailed measurements (e.g., several measurement samples per measured cell) upon detecting coverage degradation or during explicitly indicated time/location intervals. For example, referring to FIG. 9, the WTRU (e.g., WTRU 102 in FIG. 1B) is configured to perform measurement data collection and reporting using an enhanced measurement reporting procedure 900.

At 902, the WTRU is configured to receive configuration information for measurement reporting, the configuration information indicates one or more triggering conditions to start measurement and report measurement, one or more sets of parameters for measurement, and/or one or more measurement report configurations. In an example, the configuration information received by the WTRU comprises a first set of triggering conditions to start measurements, a second set of triggering conditions to report measurements, a first set of parameters and a second set of parameters for measurement, and/or one or more measurement report configurations. The first or the second set of triggering conditions comprise any of: QoS degradation of serving cell, neighbor cell measurement compared to a threshold, time, an indication from network, a measurement report size, and/or legacy reporting triggers. The one or more measurement report configurations comprise a maximum payload size and/or a pre-configured measurement reporting instance or time.

At 904, the WTRU is configured to perform one or more data measurements on at least one cell using the one or more sets of parameters and based on the one or more triggering conditions. In an example, the WTRU is configured to perform, based on the first triggering condition being satisfied for at least one cell, 1) a first measurement on the at least one cell using the first set of parameters, and 2) a second measurement on the at least one cell using the second set of parameters.

At 906, the WTRU may be configured to store or obtain the one or more data measurements and respective sets of measurement parameters based on the received configuration information and/or the one or more triggering conditions. In an example, the WTRU may store one or more measurement sample values and/or associated measurement parameters based on the received configuration information and/or a triggering condition.

At 908, the WTRU is configured to transmit one or more measurement reports based on the one or more triggering conditions. The WTRU is also configured to transmit the one or more measurement reports based on (and/or using) one or more measurement report configurations. In an example, the WTRU is configured to transmit, based on the second triggering condition being satisfied and the measurement report configuration, a measurement report including at least the first measurement or the second measurement. In another example, the WTRU may transmit one or more measurement reports including a subset of the one or more measurement sample values and/or the associated measurement parameters, based on one or more measurement report configurations and/or a second triggering condition to report measurements being satisfied. In some cases, the one or more measurement reports may be transmitted based on an RLF trigger and comprise snapshot information of measurements on 1) a configured 3GPP RAT, 2) a non-configured 3GPP RAT, or 3) a non-3GPP RAT.

In various embodiments, a WTRU (e.g., WTRU 102 in FIG. 1B) may be configured with one or more configurations and/or to perform one or more procedures discussed above. In an example, the WTRU may receive configuration information from the network, the configuration information may include instructions and/or indications to instruct the WTRU to perform detailed measurement storage and/or reporting. The configuration information may include one or more of the following: information about the serving and/or neighboring cells to be measured (e.g., explicit list of cells IDs, list of frequencies, etc.); triggering condition(s) for starting and/or stopping of the detailed measurements, such as: absolute/relative time interval windows, absolute/relative location interval windows, absolute radio signal level thresholds of serving cells, absolute radio signal level thresholds of neighboring cells, relative radio signal level thresholds between serving and neighboring cells, and/or WTRU perceived QoS performance of active radio bearers; and/or configurations for measurement reporting (e.g., the type of measurement to be reported, the amount of measurement to be reported, etc.).

The WTRU may be configured to perform detailed measurement storage when one or more conditions (e.g., condition(s) for performing and/or storing detailed measurements) are fulfilled. The WTRU may be configured to stop performing detailed measurement storage when the conditions for performing and/or storing detailed measurements are not fulfilled. The WTRU may be configured to indicate to the network the availability of detailed measurements. The WTRU may be configured to send to the network the detailed measurements (e.g., in response to or based on explicit request from the network, or based on the fulfillment of pre-configured conditions, etc.,)

Various embodiments discussed herein may use RRC signaling to configure the WTRU with trigger conditions (or interval windows) to start/stop detailed measurement gathering and reporting. It should be noted that this is not limiting and other options are also possible that can be used in addition to or as an alternative to the RRC based signaling. For example, RRC signaling can be used to configure the WTRU with the configuration of what additional measurements it should gather, but the start/stop of the detailed measurement gathering can be triggered explicitly or directly by the network (e.g., via a MAC Control Element (CE) or downlink control information (DCI)). The WTRU may start/stop the configured detailed measurement gathering/collection upon the reception of the MAC CE or DCI. As another example, a MAC CE or DCI may be used to request the detailed measurements from the WTRU. The WTRU may also use a MAC CE to indicate to the network the availability of detailed measurements.

### CONCLUSION

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, 6 or means-plus-function claim format, and any claim without the terms “means for” is not so intended.

A processor in association with software may be used to implement a radio frequency transceiver for use in a wireless transmit receive unit (WTRU), user equipment (UE), terminal, base station, Mobility Management Entity (MME) or Evolved Packet Core (EPC), or any host computer. The WTRU may be used conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Although the invention has been described in terms of communication systems, it is contemplated that the systems may be implemented in software on microprocessors/general purpose computers (not shown). In certain embodiments, one or more of the functions of the various components may be implemented in software that controls a general-purpose computer.

What is claimed is:

1. A method implemented by a wireless transmit/receive unit (WTRU) for wireless communications, the method comprising:
receiving configuration information for measurement reporting, wherein the configuration information indicates 1) a first triggering condition to start measurement, 2) a second triggering condition to report measurement, 3) a first set of parameters and a second set of parameters for measurement, and 4) a measurement report configuration;
performing, based on the first triggering condition being satisfied for at least one cell, 1) a first measurement on the at least one cell using the first set of parameters, and 2) a second measurement on the at least one cell using the second set of parameters; and
transmitting, based on the second triggering condition being satisfied and the measurement report configuration, a measurement report including at least the first measurement or the second measurement.

2. The method of claim 1, wherein the measurement report includes the first measurement and the second measurement and is transmitted using the measurement report configuration.

3. The method of claim 1, wherein the first triggering condition comprises any of: information indicating a quality of service (QOS) degradation of the at least one cell, a measurement result for the at least one cell being equal to or less than a threshold, or an indication from a network.

4. The method of claim 1, wherein the second triggering condition comprises any of: information indicating a quality of service (QOS) degradation of the at least one cell, a measurement result for the at least one cell being equal to or less than a threshold, an indication from a network, information indicating a measurement report size, or a radio link failure (RLF).

5. The method of claim 1, wherein the measurement report configuration comprises any of: a maximum payload size, a measurement report size, a pre-configured measurement reporting instance, or a pre-configured measurement reporting time.

6. The method of claim 1, wherein the measurement report is based on an RLF trigger and comprises snapshot information of measurement on the at least one cell.

7. The method of claim 6, wherein the at least one cell comprises a cell associated with a configured radio access technology (RAT) or a non-configured RAT.

8. The method of claim 1, wherein the configuration information indicates the WTRU to perform measurement storage.

9-18. (canceled)

19. A wireless transmit/receive unit (WTRU) for wireless communications, the WTRU comprising circuitry, including a transmitter, a receiver, a processor, and memory, configured to:
receive configuration information for measurement reporting, wherein the configuration information indicates 1) a first triggering condition to start measurement, 2) a second triggering condition to report measurement, 3) a first set of parameters and a second set of parameters for measurement, and 4) a measurement report configuration;
perform, based on the first triggering condition being satisfied for at least one cell, 1) a first measurement on the at least one cell using the first set of parameters, and 2) a second measurement on the at least one cell using the second set of parameters; and
transmit, based on the second triggering condition being satisfied and the measurement report configuration, a measurement report including at least the first measurement or the second measurement.

20. The WTRU of claim 19, wherein the WTRU is further configured to transmit the measurement report including the first measurement and the second measurement using the measurement report configuration.

21. The WTRU of claim 19, wherein the first triggering condition comprises any of: information indicating a quality of service (QOS) degradation of the at least one cell, a measurement result for the at least one cell being equal to or less than a threshold, or an indication from a network.

22. The WTRU of claim 19, wherein the second triggering condition comprises any of: information indicating a quality of service (QOS) degradation of the at least one cell, a measurement result for the at least one cell being equal to or less than a threshold, an indication from a network, information indicating a measurement report size, or a radio link failure (RLF).

23. The WTRU of claim 19, wherein the measurement report configuration comprises any of: a maximum payload size, a measurement report size, a pre-configured measurement reporting instance, or a pre-configured measurement reporting time.

24. The WTRU of claim 19, wherein the measurement report is based on an RLF trigger and comprises snapshot information of measurement on the at least one cell.

25. The WTRU of claim 24, wherein the at least one cell comprises a cell associated with a configured radio access technology (RAT) or a non-configured RAT.

26. The A-wireless transmit/receive unit (WTRU) of claim 19, wherein the configuration information indicates the WTRU to perform measurement storage.

27. The method of claim 1, wherein the configuration information indicates a first radio access technology (RAT) and a second RAT for performing measurements, and wherein the first measurement is performed via the first RAT using the first set of parameters, and the second measurement is performed via the second RAT using the second set of parameters.

28. The method of claim 1, wherein the first and second measurements are conducted while the WTRU is in an inactive state, wherein the measurement report is transmitted while the WTRU is in an active state, and wherein the second triggering condition comprises the WTRU transitioning into the active state.

29. The WTRU of claim 19, wherein the configuration information indicates a first radio access technology (RAT) and a second RAT for performing measurements, and wherein the processor and memory are configured to perform the first measurement via the first RAT using the first set of parameters, and perform the second measurement via the second RAT using the second set of parameters.

30. The WTRU of claim 19, wherein the processor and memory are configured to:
conduct the first and second measurements while the WTRU is in an inactive state; and
transmit the measurement report while the WTRU is in an active state, wherein the second triggering condition comprises the WTRU transitioning into the active state.
